(19) United States
(12) Patent Application Publication
(10) Pub. No.: US 2026/0302605 A1
(43) Pub. Date: Oct. 1, 2026

(54) ANTENNA ASSEMBLY WITH ALIGNED MULTIPLE RF BAND ANTENNA ELEMENTS ISOLATED BY ORTHOGONAL GROUND CURRENT PATH OPERATING IN CHASSIS MODE

(71) Applicant: MOTOROLA MOBILITY LLC, WILMINGTON, DE (US)

(72) Inventors: ANDRIUS LIETUVNINKAS, CHICAGO, IL (US); JUNSHENG ZHAO, VERNON HILLS, IL (US); XUYUAN PAN, CHICAGO, IL (US); MD FAISAL ABEDIN, CHICAGO, IL (US)

(21) Appl. No.: 19/095,162

(22) Filed: Mar. 31, 2025

(51) Int. Cl. H01Q 1/52; H01Q 1/22; H01Q 5/307; H01Q 9/04

(52) U.S. Cl. CPC H01Q 1/521; H01Q 1/22; H01Q 5/307; H01Q 9/0421

(57) ABSTRACT

A mounted antenna assembly provides multiple antennas in small spaces such as edges of communication device to support more RF communication bands, multiple input multiple output (MIMO) operation and spatial diversity. The mounted antenna assembly includes a circuit board coupled to a device support structure of a communication device. The circuit board includes an outer ground layer, a first signal feed, and a second signal feed. An antenna assembly is coupled to the device support structure and a first antenna and a second antenna. that are at least partially proximally aligned. The second antenna is sized shorter than an orthogonal contiguous current path passing through the outer ground layer to provide a primary chassis mode of radiation from the outer ground layer, electromagnetically isolating the second antenna from the first antenna.

### BACKGROUND

### 1. Technical Field

The present disclosure relates generally to mobile communication devices, and more particularly to mobile communication devices having multiple edge antenna elements.

### 2. Description of the Related Art

Portable communication devices and small Internet of Things (IoT) devices have small design form factors that provide limited space for antennas required for radio frequency communications. Portable communication devices often require around ten (10) antennas to meet connectivity needs. In an example, a small accessory device may include support for cellular network connectivity, enclosed modem, and baseband RF systems for calling and text functions. Antennas capable of supporting low band, medium, high band, etc., have to be placed in proximity of each other without creating high coupling with other antennas and without degradation of antenna radiation.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented including a mounted antenna assembly with aligned multiple radio frequency band antenna elements isolated by an orthogonal feedline operating in chassis mode, according to one or more embodiments;

FIG. 1B is an additional block diagram representation of the electronic device of FIG. 1A presenting additional components, including components for wireless communications with other devices, according to one or more embodiments;

FIG. 2 is a front view of the electronic device including an example implementation of the mounted antenna assembly, according to one or more embodiments;

FIG. 3 is a table of optional configurations of four antennas of the mounted antenna assembly, according to one or more embodiments;

FIG. 4 is a three-dimensional view of the example implementation of the mounted antenna assembly of FIG. 2, according to one or more embodiments;

FIG. 5A is a diagram of a conventional low band (LB), medium band (MB), high band (HB) inverted-L antenna (ILA) or inverted-F antenna (IFA) first antenna with a typical graphical plot of electrical current along each orthogonal antenna element, according to one or more embodiments;

FIG. 5B is a diagram of a conventional MB/HB second antenna with a typical graphical plot of electrical current along the antenna, according to one or more embodiments;

FIG. 5C is a diagram of the conventional first antenna of FIG. 5A and the conventional second antenna of FIG. 5B with a graphical plot of primary and induced secondary electrical current levels respectively in the second antenna and the first antenna, according to one or more embodiments;

FIG. 5D is a diagram of the conventional first antenna of FIG. 5A and a shortened second antenna of FIG. 2 having a ground current path operating in chassis mode with a graphical plot of reduced primary current in the second antenna and induced secondary current in the first antenna, according to one or more embodiments;

FIG. 6A presents a graphical plot of antenna isolation in LB as a function of frequency between first and second antennas, according to one or more embodiments;

FIG. 6B presents a graphical plot of antenna isolation in MB and HB between pairs of the four antennas of the mounted antenna assembly, according to one or more embodiments;

FIG. 6C presents a graphical plot of voltage standing wave ratio (VSWR) versus frequency in LB for the first and second antennas of the mounted antenna assembly, according to one or more embodiments;

FIG. 6D presents a graphical plot of radiation efficiency versus frequency in LB for the first and second antennas of the mounted antenna assembly, according to one or more embodiments;

FIG. 6E presents graphical plots of VSWR versus frequency in MB, HB and ultra-high band (HB) for each of the four antennas of the mounted antenna assembly, according to one or more embodiments;

FIG. 6F presents a graphical plot of radiation efficiency versus frequency in MB, HB, and UHB for each of the four antennas of the mounted antenna assembly, according to one or more embodiments; and

FIG. 7A-7B (collectively “FIG. 7”) is a flow diagram presenting a method of making an electronic device having the mounted antenna assembly with an ILA first antenna that is isolated from a closely aligned and shortened second antenna having a ground current path operating in chassis mode, according to one or more embodiments.

### DETAILED DESCRIPTION

According to aspects of the present disclosure, a mounted antenna assembly, a communication device that incorporates the mounted antenna assembly, and a method of making the mounted antenna assembly provide for closely positioning pairs of aligned antenna elements that operate in overlapping radio frequency (RF) bands without excess coupling and degradation of antenna radiation. With more antennas being provided in devices with a small design form factor, additional communication modes are supportable such as different cellular bands and wireless bands. More antennas also support multiple input multiple output (MIMO) to achieve directed antenna gain and spatial diversity to overcome antenna blocking.

According to one or more embodiments, a mounted antenna assembly includes a device support structure. The mounted antenna assembly includes a circuit board coupled to the device support structure and having an outer ground layer, a first signal feed, and a second signal feed. The mounted antenna assembly includes an antenna assembly coupled to the device support structure. The antenna assembly includes a first antenna having a first end electrically coupled to the first signal feed at a first edge of the device support structure. The first antenna has a second end extending along and aligned with a second edge of the device support structure, the second edge adjacent and orthogonal to the first edge. The antenna assembly includes a second antenna having a third end electrically coupled to the second signal feed positioned on the second edge of the device support structure. The second antenna has a fourth end extending in an opposite direction and proximally with the second end of the first antenna. The second antenna is sized shorter than an orthogonal contiguous current path passing through the outer ground layer to provide a primary chassis mode of radiation from the outer ground layer, electromagnetically isolating the second antenna from the first antenna.

According to one or more embodiments, a communication device includes the mounted antenna assembly. The communication device includes a communications subsystem communicatively coupled to the mounted antenna assembly to at least one of transmit and receive a radio frequency (RF) signal.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc., do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

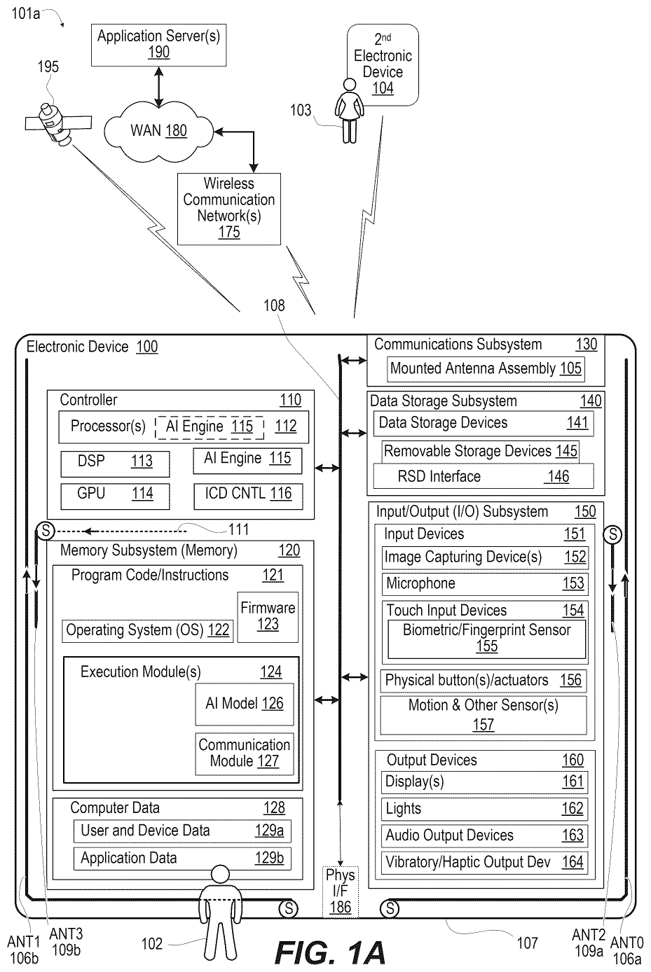

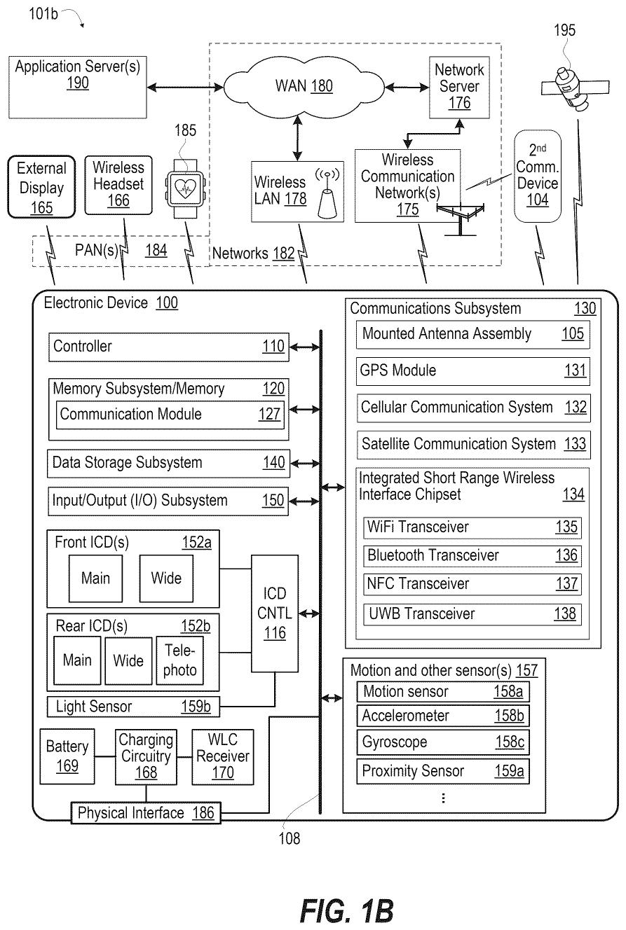

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

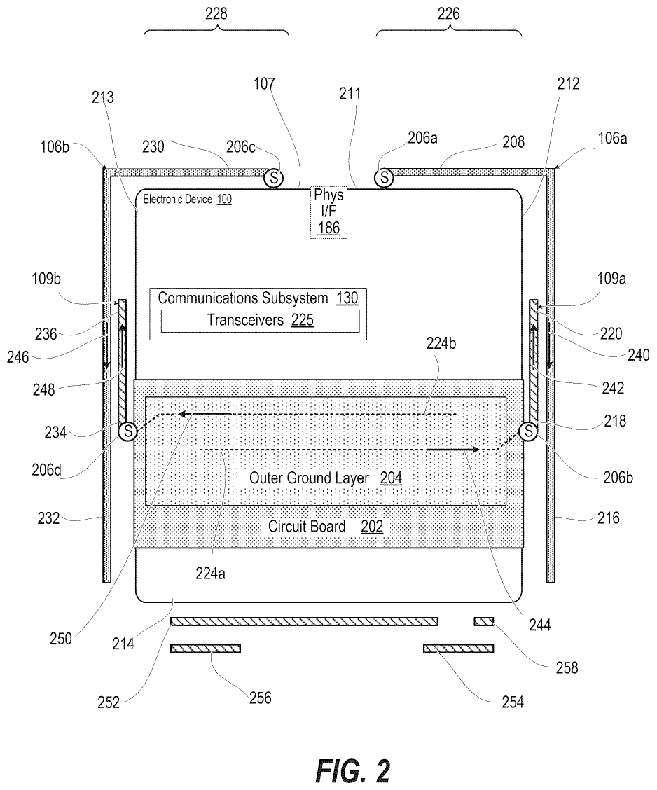

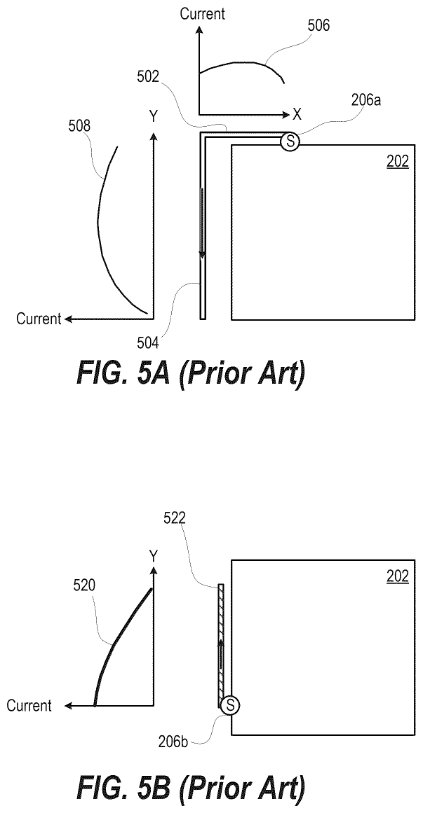

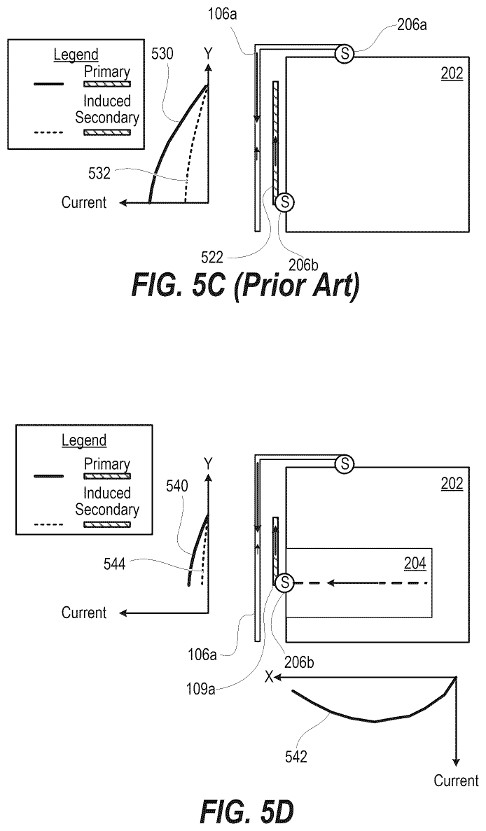

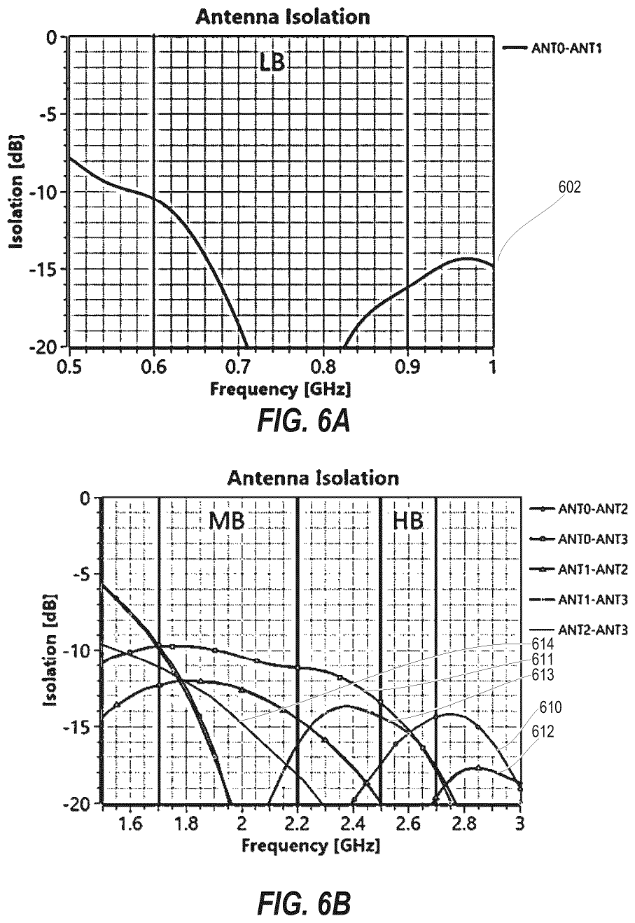

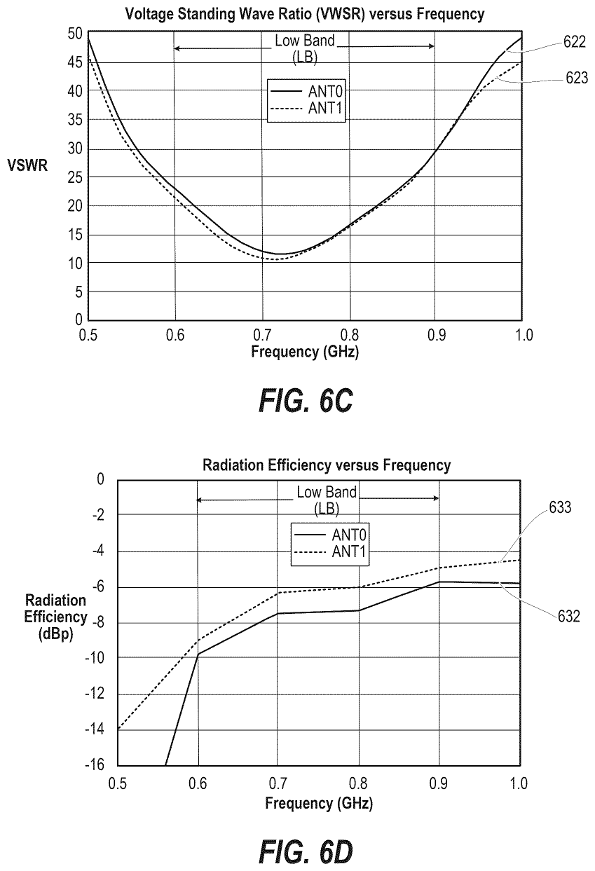

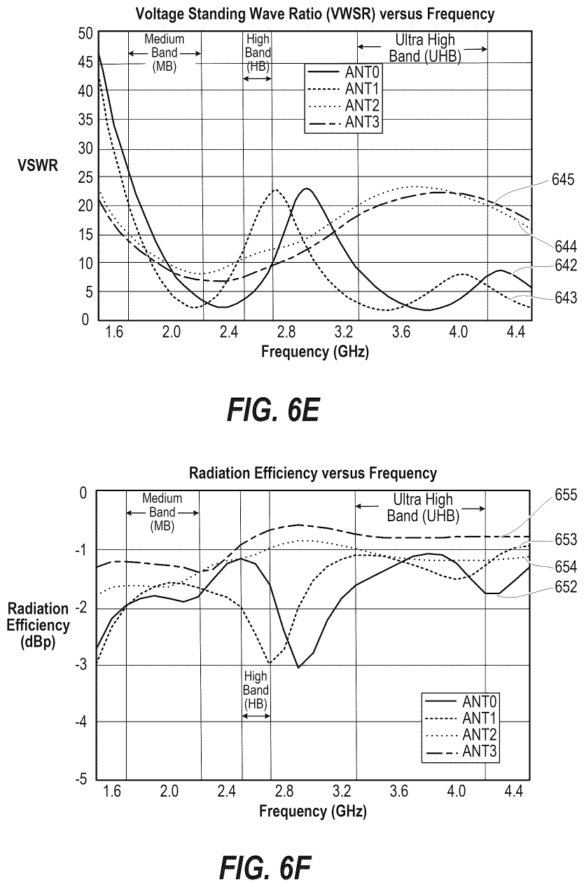

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, a heads up display (e.g., smart glasses) worn by user 102, and other types of electronic devices. For purposes of this disclosure, electronic device is assumed to be a communication device that can be used to communicate with second user(s) 103 who use corresponding second electronic device(s) 104. Electronic device 100 can therefore be interchangeably referred to herein as a communication device. Communication is supported at least in part by mounted antenna assembly 105 that tightly integrates at least one pair of antenna that are aligned in parallel in close spacing without significant interference between antennas. In an example, first antenna 106a is paired with second antenna 109a and third antenna 106b is paired with fourth antenna 109b. Examples of configurations of mounted antenna assembly 105 are described below with regard to FIG. 2-4. The theory of the radiation isolation between the paired antennas using an orthogonal ground current path 111 operating in chassis mode is described with regard to FIG. 5A-5D. Simulated results depicting the radiation isolation are provided in FIG. 6A-6F.

Electronic device 100 generally includes controller 110, memory (or memory subsystem) 120, communication subsystem 130, data storage subsystem 140, input/output subsystem 150, all contained within or extended from an exterior surface of device housing 107. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 includes, without limitation, communication module 127, which provides the features and operating functionality of the disclosed embodiments when the corresponding program instructions of communication module 127 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within communication module 127 and is trained to support the AI features of communication module 127. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of AI model(s) 126 and communication module 127, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 107. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 107 along with front image capturing devices (not specifically shown), while the higher quality ICDs are located on a rear surface of device housing 107. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of communication module 127 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 186. Physical interface 186 of electronic device 100 can serve as an input/output data port and can be used as a power supply port that is coupled to charging circuitry 168 which feeds electrical power to device battery 169 to enable recharging of device battery 169 and/or powering of electronic device 100. Alternatively, or in addition, Wireless charging (WLC) receiver 170 may include one or more magnetic loop antennas in which a current is induced by receiving an oscillating magnetic field. WLC receiver 170 provides the current to charging circuit 168. As a data port, physical interface 186 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

FIG. 2 is a front view of a communication device (e.g., electronic device 100) including an example implementation of mounted antenna assembly 105 (FIG. 1A) coupled to a device support structure (e.g., housing 107). Electronic device 100 includes circuit board 202 coupled to the device support structure. Circuit board 202 includes outer ground layer 204, first signal feed 206a, and second signal feed 206b. Electronic device 100 includes mounted antenna assembly 105 coupled to the device support structure. Mounted antenna assembly 105 includes first antenna 106a and second antenna 109a. First antenna 106a includes first end 208 that is electrically coupled to first signal feed 206a at first edge 211 of the device support structure (i.e., housing 107). In an example, first edge 211 is a top edge, second edge 212 is a right edge, third edge 213 is a left edge, and fourth edge 214 is a bottom edge as viewed. Second edge 212 is adjacent and orthogonal to first edge 211. First antenna 106a has second end 216 extending along and aligned with second edge 212 of the device support structure. Second antenna 109a includes third end 218 electrically coupled to second signal feed 206b positioned on second edge 212 of the device support structure (i.e., housing 107). Second antenna 109a includes fourth end 220 extending in an opposite direction and proximally with second end 216 of first antenna 106a. A conventional second antenna 522 (FIG. 5B) would be longer than second antenna 109a to support the same RF bands. Second antenna 109a is sized shorter than first orthogonal contiguous current path 224a passing through outer ground layer 204 to provide a primary chassis mode of radiation from outer ground layer 204, electromagnetically isolating second antenna 109a from first antenna 106a. Electronic device 100 includes communications subsystem 130 having transceivers 225 communicatively coupled to the mounted antenna assembly 105 enabling electronic device 100 to at least one of transmit and/or receive a radio frequency (RF) signal.

In order to support multiple input multiple output (MIMO) operation and spatial diversity, another antenna pair is positioned on an opposite side of housing 107 of electronic device 100. In one or more embodiments, mounted antenna assembly 105 is configured to support two-by-two low band MIMO operation and four-by-four medium band or high band MIMO operation. Circuit board 202 includes third signal feed 206c and fourth signal feed 206d. First end 208 of first antenna 106a is on first portion 226 of first edge 211 of the device support structure (e.g., housing 107) adjacent to second edge 212. In an example, first portion 226 of first edge 211 is to the left of physical interface 186, as depicted. Second portion 228 of first edge 211 is to the right of physical interface 186, as depicted. Third antenna 106b includes fifth end 230 that is electrically coupled to third signal feed 206c at second portion 228 of first edge 211 of the device support structure, adjacent to third edge 213 of the device structure. Third edge 213 is orthogonal to first edge 211 and opposite to second edge 212. Third antenna 106b has sixth end 232 extending along and aligned with third edge 213 of the device support structure (e.g., housing 107). Fourth antenna 109b includes seventh end 234 electrically coupled to fourth signal feed 206d positioned on third edge 213 of the device support structure. Fourth antenna 109b includes eighth end 236 extending in an opposite direction (e.g., upward as depicted) and proximally with sixth end 232 of third antenna 106b. Fourth antenna 109b is sized shorter than conventional antenna 522 (FIG. 5B). Fourth antenna 109b has second orthogonal contiguous current path 224b passing through outer ground layer 204 that has a length sufficient to provide a primary chassis mode of radiation from outer ground layer 204, electromagnetically isolating fourth antenna 109b from third antenna 106b.

Third antenna 106b and fourth antenna 109b are closely spaced and parallel aligned in an identical or similar arrangement to first antenna 106a and second antenna 109a. Fourth antenna 109b is configured to operate in chassis mode to achieve the same radiation isolation to third antenna 106b. As traditionally referenced, first antenna 106a is “ANT0”, third antenna 106b is “ANT1”, second antenna 109a is “ANT2”, and fourth antenna 109b is “ANT3”. Antenna performance of first antenna 106a is indicated by ANT0 primary current 240. Antenna performance of second antenna 109a is indicated by ANT1 primary current 242 that is in an opposite direction (e.g., upward as depicted) to ANT0 primary current 240. Antenna performance of second antenna 109a is also indicated by ANT1 ground current 244 in first orthogonal contiguous current path 224a. Antenna performance of third antenna 106b is indicated by ANT2 primary current 246. Antenna performance of fourth antenna 109b is indicated by ANT3 primary current 248 and ANT3 ground current 250. Shortening the aligned overlap between antenna pairs while lengthening orthogonal ground current to operate in chassis mode reduces interference as described below with regard to FIG. 5A-5D.

In one or more embodiments, mounted antenna assembly 105 includes one or more antennas positioned on fourth edge 214 (e.g., bottom edge as depicted) opposite to first edge 211 of the device support structure (e.g., housing 107). The one or more antennas are configured respectively for: (i) a global positioning system (GPS) radio frequency (RF) band; (ii) a wireless RF band; and (iii) an ultra-wideband (UWB) RF band. In an example, fifth antenna “ANT4” 252, which may be a standalone antenna, is configured for GPS. Sixth antenna “ANT5” 254 is operated by first transceiver “TRX1” for Wi-Fi in 2.4/5 GHz RF bands. Seventh antenna “ANT6” 256 is operated by second transceiver “TRX2” for Wi-Fi in 2.4/5 GHz RF bands. In one or more embodiments, one antenna may support both Wi-Fi and GPS functions. Eighth antenna “ANT7” 258, which may be co-located with any antenna including cellular antennas, is configured for UWB.

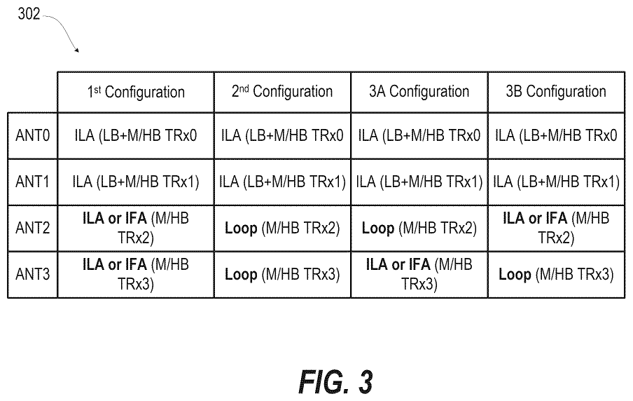

FIG. 3 is table 302 of optional configurations of four antennas, ANT0, ANT1, ANT2, and ANT3 of mounted antenna assembly 105, where ANT0 is first antenna 106a operated by first transceiver (“TRx0”), ANT1 is third antenna 106b operated by second transceiver (“TRx1”), ANT2 is second antenna 109a operated by third transceiver (“TRx3”), and ANT3 is fourth antenna 109b (FIG. 2) operated by fourth transceiver (“TRx4”). In an example, first antenna 106a (ANT0) is one of an inverted-L antenna (ILA) or an inverted-F antenna (IFA) configured for low band (LB), medium band (MB), and high band (HB) operation for all of the configurations. Third antenna 106b (ANT1) is one of an ILA or an IFA configured for LB, MB, and HB operation for all of the configurations.

In a first configuration example, ANT2 (i.e., second antenna 109a of FIG. 2) and ANT3 (i.e., fourth antenna 109b of FIG. 2) are both either an ILA or an IFA configured to operate in MB and HB. Second signal feed 206b and fourth signal feed 206d are positioned near a center, respectively, of second edge 212 and third edge 213 of housing 107, as depicted in FIG. 2.

In a second configuration example, ANT2 (i.e., second antenna 109a of FIG. 2) and ANT3 (i.e., fourth antenna 109b of FIG. 2) are both loop antennas configured to operate in MB and HB, respectively, configured as TRx2 and TRx3. Second signal feed 206b and fourth signal feed 206d are not necessarily positioned near a center respectively of second edge 212 and third edge 213 of housing 107.

In a third configuration example (“3A”), ANT2 (i.e., second antenna 109a of FIG. 2) is a loop antenna configured to operate in MB and HB as TRx2. ANT3 (i.e., fourth antenna 109b of FIG. 2) is either an ILA or an IFA configured to operate in MB and HB as TRx3. Second signal feed 206b is not necessarily positioned near a center respectively of second edge 212 of housing 107. Fourth signal feed 206d is positioned near a center of third edge 213 of housing 107, as depicted in FIG. 2.

In a mirrored third configuration example (“3B”), ANT2 (i.e., second antenna 109a of FIG. 2) is either an ILA or an IFA configured to operate in MB and HB as TRx4. ANT3 (i.e., fourth antenna 109b of FIG. 2) is a loop antenna configured to operate in MB and HB as TRx3. Second signal feed 206b is positioned near a center of second third edge 212 of housing 107 as depicted in FIG. 2. Fourth signal feed 206d is not necessarily positioned near a center respectively of third edge 213 of housing 107.

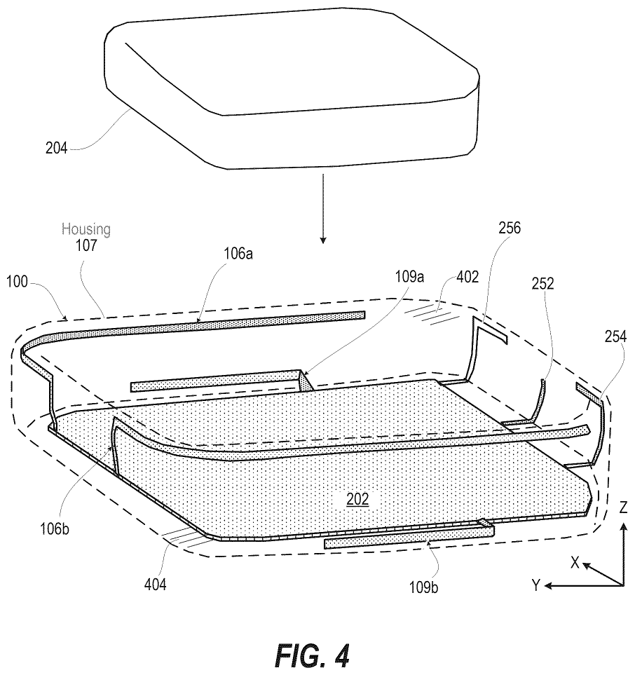

FIG. 4 is a three-dimensional view of the example implementation of mounted antenna assembly 105 and circuit board 202 within the device structure (e.g., housing 107) having a depth dimension along a Z-axis between front side 402 and back side 404. Back side 404 is parallel to and spaced apart in a depth dimension from front side 402. Front side 402 and back side 404 both extend orthogonally from first edge 211, second edge 212, third edge 213, and fourth edge 214. Second antenna 109a and fourth antenna 109b are positioned near back side 404 in a different plane respectively in the depth dimension from first antenna 106a and third antenna 106b that are near front side 402. Outer ground layer 204 is depicted as removed from circuit board 202 for clarity.

FIG. 5A is a diagram of a conventional low band (LB), medium band (MB), high band (HB) ILA first antenna 106a having horizonal antenna element 502 with a corner attachment to vertical element 504. FIG. 5A also presents two typical graphical plots of electrical current along each orthogonal antenna element. Horizontal current distribution graphical plot 506 indicates typical current strength in horizontal element 502. Vertical current distribution graphical plot 508 indicates typical current strength in vertical element 504.

FIG. 5B is a diagram of a conventional MB/HB second antenna 522 with typical graphical plot 520 of electrical current along the antenna. The current is mainly on the antenna element or trace and is not operating in chassis mode.

FIG. 5C is a diagram of first antenna 106a proximally placed in alignment with conventional second antenna 522. The size of the overlapping length of second antenna 522 and the strength of primary current in second antenna 522 indicated by graphical plot 530 creates a significant induced secondary current in first antenna 106a, as indicated by graphical plot 532. The induced secondary current interferes with operation by first antenna 106a and reduces radiation efficiency of second antenna 522.

FIG. 5D is a diagram of the conventional first antenna of FIG. 5A and a shortened second antenna 109a according to the present disclosure having an orthogonal ground current path operating in chassis mode. The shorter overlap of second antenna 109a reduces the opportunity for coupling. In addition, the primary current strength in second antenna 109a is reduced as indicated by graphical plot 540, when compared to orthogonal ground current as indicated by plot 542. The resulting induced secondary current as indicated by plot 544 is significantly reduced, compared to the conventional situation depicted in FIG. 5C. Since second antenna 109a is much shorter than conventional second antenna 522, the antenna element acts as an exciter and not as a radiator. The second antenna element 109a excites the chassis mode, while outer ground layer 204 radiates the signal. As the current of the chassis mode is orthogonal to the first antenna, the second antenna may be collocated with the first antenna as the arrangement reduces coupling and improves antenna isolation.

FIG. 6A presents graphical plot 602 of antenna isolation in LB as a function of frequency between first antenna “ANT0” and third antenna “ANT1”. Graphical plot 602 is based on simulation. The other antennas of the mounted antenna assembly are not configured for LB. The isolation is around −10 dB at the lower frequency bound 0.6 GHz of LB and better through the rest of LB.

FIG. 6B presents a graphical plot containing plot lines 610-614 of antenna isolation in MB and HB between pairs of the four antennas of the mounted antenna assembly that are configured to operate in MB and HB. Plot line 610 illustrates antenna isolation between ANT0 and ANT2. Plot line 611 illustrates antenna isolation between ANT0 and ANT3. Plot line 612 illustrates antenna isolation between ANT1 and ANT2. Plot line 613 illustrates antenna isolation between ANT1 and ANT3. Plot line 614 illustrates antenna isolation between ANT2 and ANT3. In MB, the antenna isolation is −10 dB or better. In HB, antenna isolation is −13 dB or better.

FIG. 6C presents graphical plot containing plot lines 622-623 of voltage standing wave ratio (VSWR) versus frequency in LB respectively for the first antenna ANT0 and third antenna ANT1 of the mounted antenna assembly that are configured to operate in LB. Both antennas have good LB performance by having VSWR that is less than 25.

FIG. 6D presents graphical plot containing plot lines 632-633 of radiation efficiency versus frequency in LB respectively for the first antenna ANT0 and third antenna ANT1 of the mounted antenna assembly. The antennas have good radiation efficiency of better than −10 dB.

FIG. 6E presents graphical plot containing plot lines 642, 643, 644, and 645 of VSWR versus frequency in MB, HB, and ultra-high band (UHB) for each of the four antennas of the mounted antenna assembly. The four antennas ANT0, ANT1, ANT2, and ANT3 have good medium and high band performance with VSWR below 25.

FIG. 6F presents graphical plot containing plot lines 652, 653, 654, and 655 of radiation efficiency versus frequency in MB and HB for each of the four antennas of the mounted antenna assembly. The four antennas ANT0, ANT1, ANT2, and ANT3 have good medium and high band performance with radiation efficiency better than −3 dB.

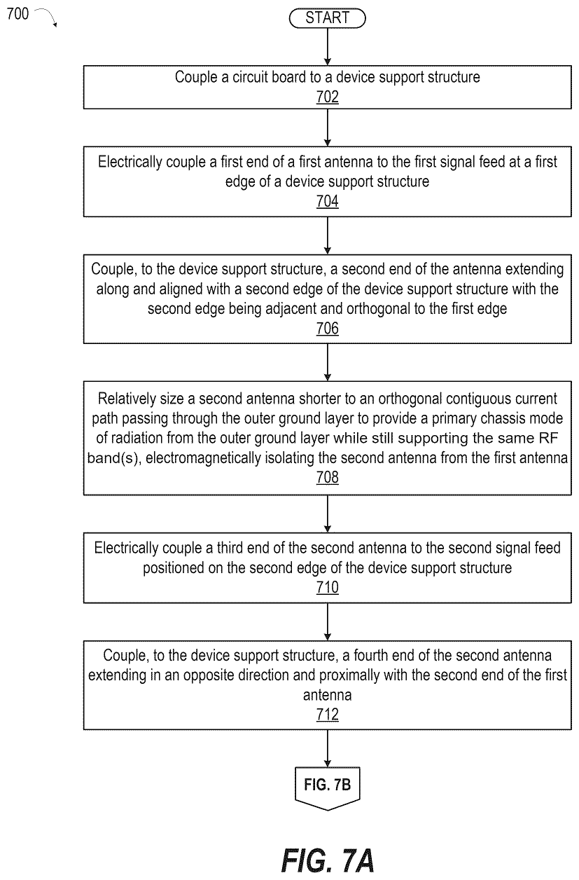

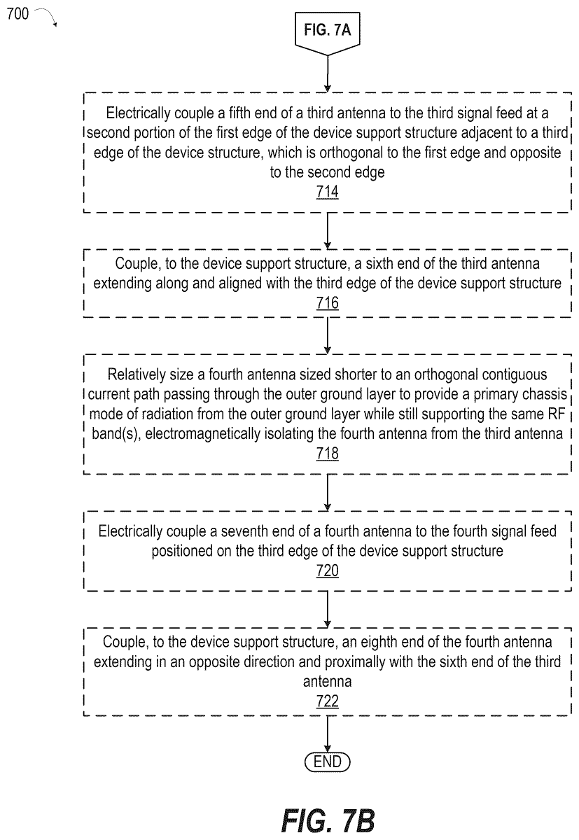

FIG. 7A-7B (collectively “FIG. 7”) provide a flow diagram presenting a method of making the electronic device having the mounted antenna assembly with an ILA first antenna that is isolated from a closely aligned and shortened second antenna having a ground current path operating in chassis mode. The description of method 700 (FIG. 7) is provided with general reference to the specific components illustrated within the preceding FIG. 1A-1B, 2-4, 5A-5D, and 6A-6F. Specific components referenced in method 700 (FIG. 7) may be identical or similar to components of the same name used in describing preceding FIG. 1A-1B, 2-4, 5A-5D, and 6A-6F.

With reference to FIG. 7A, method 700 includes coupling a circuit board to a device support structure (block 702). The circuit board includes an outer ground layer, a first signal feed, and a second signal feed. In one or more embodiments, the circuit board further includes a third signal feed and a fourth signal feed. Method 700 includes electrically coupling a first end of a first antenna to the first signal feed at a first edge of a device support structure (block 704). Method 700 includes coupling (e.g., molding, adhering, attaching, applying, welding, fastening), to the device support structure, a second end of the antenna extending along and aligned with a second edge of the device support structure, with the second edge being adjacent and orthogonal to the first edge (block 706). Method 700 includes sizing a second antenna to be shorter than an orthogonal contiguous current path passing through the outer ground layer to provide a primary chassis mode of radiation from the outer ground layer, electromagnetically isolating the second antenna from the first antenna (block 708). Method 700 includes electrically coupling a third end of the second antenna to the second signal feed, positioned on the second edge of the device support structure (block 710). Method 700 includes coupling, to the device support structure, a fourth end of the second antenna extending in an opposite direction and proximally with the second end of the first antenna (block 712).

The first end of the first antenna is on a first portion of the first edge of the device support structure adjacent to the second edge. In one or more embodiments to support MIMO operation and spatial diversity, method 700 includes electrically coupling a fifth end of a third antenna to the third signal feed at a second portion of the first edge of the device support structure adjacent to a third edge of the device structure, which is orthogonal to the first edge and opposite to the second edge (block 714). Method 700 includes coupling, to the device support structure, a sixth end of the third antenna extending along and aligned with the third edge of the device support structure (block 716). Method 700 includes relatively sizing a fourth antenna to be shorter than an orthogonal contiguous current path passing through the outer ground layer to provide a primary chassis mode of radiation from the outer ground layer while still supporting the same RF band(s), electromagnetically isolating the fourth antenna from the third antenna (block 718). Method 700 includes electrically coupling a seventh end of the fourth antenna to the fourth signal feed positioned on the third edge of the device support structure (block 720). Method 700 includes coupling, to the device support structure, an eighth end of the fourth antenna extending in an opposite direction and proximally with the sixth end of the third antenna (block 722). Then method 700 ends.

According to aspects of the present disclosure, mounted antenna assembly 105 (FIG. 1A), electronic device 100 (FIG. 1A), and method 700 (FIG. 7) provide techniques for integrating aligned antenna elements (e.g., conductive trace) in close spacing for communication devices having a small design form factor (e.g., smartphones, IoT devices). The present disclosure enables more antenna elements that operate in overlapping radio frequency (RF) bands to be closely positioned in parallel, without excess coupling and degradation of antenna radiation. With more antennas being provided in a small design form factor, additional communication modes are supportable, such as different cellular bands and wireless bands. More antennas also support multiple input multiple output (MIMO) operation to achieve directed antenna gain. More antennas also support spatial diversity to overcome antenna blocking. Degradation of antenna performance is minimized to an acceptable level by operating one of the antennas in the pair in a chassis mode, enabling a shortened antenna element with lower current levels in the same RF band and corresponding lower induced current in the other antenna of the pair. By extending these integration techniques to an additional antenna pair, mounted antenna assembly 105 (FIG. 1A) supports two-by-two low band MIMO operation and four-by-four medium band or high band MIMO operation. Simulation indicates good performance with antenna isolation below −10 dB, antenna efficiency above −10 dB, and voltage standing wave ratio (VSWR) less than 25 in low, medium, and high bands.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc., do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. A mounted antenna assembly comprising:
a device support structure;
a circuit board coupled to the device support structure and comprising an outer ground layer, a first signal feed, and a second signal feed; and
an antenna assembly coupled to the device support structure and comprising:
a first antenna comprising a first end electrically coupled to the first signal feed at a first edge of the device support structure and having a second end extending along and aligned with a second edge of the device support structure, the second edge adjacent and orthogonal to the first edge; and
a second antenna comprising a third end electrically coupled to the second signal feed positioned on the second edge of the device support structure and comprising a fourth end extending in an opposite direction and proximally with the second end of the first antenna, the second antenna sized shorter to an orthogonal contiguous current path passing through the outer ground layer to provide a primary chassis mode of radiation from the outer ground layer, electromagnetically isolating the second antenna from the first antenna.

2. The mounted antenna assembly of claim 1, wherein:
the first antenna comprises one of an inverted-L antenna (ILA) or an inverted-F antenna (IFA) configured for low band, medium band, and high band operation; and
the second antenna comprises one of an ILA, an IFA, or a loop antenna configured for medium band and high band operation.

3. The mounted antenna assembly of claim 1, wherein:
the circuit board comprises a third signal feed and a fourth signal feed;
the first end of the first antenna is on a first portion of the first edge of the device support structure adjacent to the second edge; and
the antenna assembly further comprises:
a third antenna comprising a fifth end electrically coupled to the third signal feed at a second portion of the first edge of the device support structure adjacent to a third edge of the device structure, orthogonal to the first edge and opposite to the second edge, the third antenna having a sixth end extending along and aligned with the third edge of the device support structure; and
a fourth antenna comprising a seventh end electrically coupled to the fourth signal feed positioned on the third edge of the device support structure and comprising an eighth end extending in an opposite direction and proximally with the sixth end of the third antenna, the fourth antenna sized shorter to the orthogonal contiguous current path passing through the outer ground layer to provide a primary chassis mode of radiation from the outer ground layer, electromagnetically isolating the fourth antenna from the third antenna.

4. The mounted antenna assembly of claim 3, wherein:
the first antenna and third antenna both comprise a selected one of an inverted-L antenna (ILA) and an inverted-F antenna (IFA) configured for low band, medium band, and high band operation.

5. The mounted antenna assembly of claim 4, wherein:
the second antenna and the fourth antenna are both either an ILA or an IFA to form a first configuration; and
the second signal feed and the fourth signal feed are positioned near a center respectively of the second edge and the third edge.

6. The mounted antenna assembly of claim 4, wherein the second antenna and the fourth antenna are both a loop antenna to form a second configuration.

7. The mounted antenna assembly of claim 4, wherein the second antenna is a loop antenna and the fourth antenna is an ILA or an IFA to form a third configuration.

8. The mounted antenna assembly of claim 4, wherein:
the device structure comprises a front side and a back side parallel to and spaced apart in a depth dimension from the front side, the front side and the back side both extending orthogonally from the first edge, the second edge, and the third edge, the second antenna and the fourth antenna positioned in a different plane respectively in the depth dimension from the first and third antennas.

9. The mounted antenna assembly of claim 4, wherein the first, second, third, and fourth antennas are positioned to support two-by-two low band multiple input multiple output (MIMO) operation and four-by-four medium band or high band MIMO operation.

10. The mounted antenna assembly of claim 4, further comprising one or more antennas positioned on a fourth edge opposite to the first edge of the device support structure, the one or more antennas configured respectively for: (i) a global positioning system (GPS) radio frequency (RF) band; (ii) a wireless RF band; and (iii) an ultra-wideband (UWB) RF band.

11. A communication device comprising:
a mounted antenna assembly comprising:
a device support structure;
a circuit board coupled to the device support structure and comprising an outer ground layer, a first signal feed, and a second signal feed; and
an antenna assembly coupled to the device support structure and comprising:
a first antenna comprising a first end electrically coupled to the first signal feed at a first edge of the device support structure and having a second end extending along and aligned with a second edge of the device support structure, the second edge adjacent and orthogonal to the first edge;
a second antenna comprising a third end electrically coupled to the second signal feed positioned on the second edge of the device support structure and comprising a fourth end extending in an opposite direction and proximally with the second end of the first antenna, the second antenna sized shorter to an orthogonal contiguous current path passing through the outer ground layer to provide a primary chassis mode of radiation from the outer ground layer, electromagnetically isolating the second antenna from the first antenna; and
a communications subsystem communicatively coupled to the mounted antenna assembly to at least one of transmit and receive a radio frequency (RF) signal.

12. The communication device of claim 11, wherein:
the first antenna comprises one of an inverted-L antenna (ILA) or an inverted-F antenna (IFA) configured for low band, medium band, and high band operation; and
the second antenna comprises one of an ILA, an IFA, or a loop antenna configured for medium band and high band operation.

13. The communication device of claim 11, wherein:
the circuit board comprises a third signal feed and a fourth signal feed;
the first end of the first antenna is on a first portion of the first edge of the device support structure adjacent to the second edge; and
the antenna assembly further comprises:
a third antenna comprising a fifth end electrically coupled to the third signal feed at a second portion of the first edge of the device support structure adjacent to a third edge of the device structure, orthogonal to the first edge and opposite to the second edge, the third antenna having a sixth end extending along and aligned with the third edge of the device support structure; and
a fourth antenna comprising a seventh end electrically coupled to the fourth signal feed positioned on the third edge of the device support structure and comprising an eighth end extending in an opposite direction and proximally with the sixth end of the first antenna, the fourth antenna sized shorter to the orthogonal contiguous current path passing through the outer ground layer to provide a primary chassis mode of radiation from the outer ground layer, electromagnetically isolating the fourth antenna from the third antenna.

14. The communication device of claim 13, wherein:
the first antenna and third antenna both comprise a selected one of an inverted-L antenna (ILA) and an inverted-F antenna (IFA) configured for low band, medium band, and high band operation.

15. The communication device of claim 14, wherein:
the second antenna and the fourth antenna are both either an ILA or an IFA to form a first configuration; and
the second signal feed and the fourth signal feed are positioned near a center respectively of the second edge and the third edge.

16. The communication device of claim 14, wherein the second antenna and the fourth antenna are both a loop antenna to form a second configuration.

17. The communication device of claim 14, wherein the second antenna is a loop antenna and the fourth antenna is an ILA or an IFA to form a third configuration.

18. The communication device of claim 14, further comprising one or more antennas positioned on a fourth edge opposite to the first edge of the device support structure, the one or more antennas configured respectively for: (i) a global positioning system (GPS) radio frequency (RF) band; (ii) a wireless RF band; and (iii) an ultra-wideband (UWB) RF band, wherein:
the device structure comprises a front side and a back side parallel to and spaced apart in a depth dimension from the front side, the front side and the back side both extending orthogonally from the first edge, the second edge, and the third edge, the second antenna and the fourth antenna positioned in a different plane respectively in the depth dimension from the first and third antennas; and
the first, second, third, and fourth antennas are positioned to support two-by-two low band multiple input multiple output (MIMO) operation and four-by-four medium band or high band MIMO operation.

19. A method comprising:
coupling a circuit board to a device support structure, the circuit board comprising an outer ground layer, a first signal feed, and a second signal feed;
electrically coupling a first end of a first antenna to the first signal feed at a first edge of a device support structure;
coupling, to the device support structure, a second end of the antenna extending along and aligned with a second edge of the device support structure, the second edge adjacent and orthogonal to the first edge;
electrically coupling a third end of a second antenna to the second signal feed positioned on the second edge of the device support structure;
coupling, to the device support structure, a fourth end of the second antenna extending in an opposite direction and proximally with the second end of the first antenna, the second antenna sized shorter to an orthogonal contiguous current path passing through the outer ground layer to provide a primary chassis mode of radiation from the outer ground layer, electromagnetically isolating the second antenna from the first antenna.

20. The method of claim 19, wherein:
the circuit board comprises a third signal feed and a fourth signal feed;
the first end of the first antenna is on a first portion of the first edge of the device support structure adjacent to the second edge; and
the method further comprises:
electrically coupling a fifth end of a third antenna to the third signal feed at a second portion of the first edge of the device support structure adjacent to a third edge of the device structure, orthogonal to the first edge and opposite to the second edge;
coupling, to the device support structure, a sixth end of the third antenna extending along and aligned with the third edge of the device support structure;
electrically coupling a seventh end of a fourth antenna to the fourth signal feed positioned on the third edge of the device support structure; and
coupling, to the device support structure, an eighth end of the fourth antenna extending in an opposite direction and proximally with the sixth end of the first antenna, the fourth antenna sized shorter to an orthogonal contiguous current path passing through the outer ground layer to provide a primary chassis mode of radiation from the outer ground layer, electromagnetically isolating the fourth antenna from the third antenna.
